(19) United States
(12) Patent Application Publication
(10) Pub. No.: US 2013/0316597 A1
(43) Pub. Date: Nov. 28, 2013

(54) POWER CONNECTOR AND CENTER TERMINAL

(71) Applicant: Hung-Tien Chang, Taipei City (TW)

(72) Inventor: Hung-Tien Chang, Taipei City (TW)

(73) Assignee: COMPAL ELECTRONICS, INC., Taipei City (TW)

(21) Appl. No.: 13/556,179

(22) Filed: Jul. 23, 2012

(30) Foreign Application Priority Data
May 23, 2012 (TW) 101118345

(51) Int. Cl. H01R 24/76

(52) U.S. Cl. 439/732

(57) ABSTRACT

A power connector suitable for being mounted on a circuit board includes an insulating housing and a center terminal. The insulating housing has a plug hole. The center terminal has a center fixing portion, a center contact portion and a center soldering portion. The center fixing portion is fixed into the insulating housing, the center contact portion extends into the plug hole, and the center soldering portion is suitable for passing through a center soldering hole of the circuit board to be soldered to the circuit board. The center soldering portion has a waist segment and a tail segment extending from the waist segment, the waist segment is located inside the center soldering hole, and the minimum transection area of the waist segment is less than the maximum transection area of the tail segment. A center terminal suitable for being utilized in a power connector is also provided.

### CROSS-REFERENCE TO RELATED APPLICATION

This application claims the priority benefit of Taiwan application serial no. 101118345, filed on May 23, 2012. The entirety of the above-mentioned patent application is hereby incorporated by reference herein and made a part of this specification.

### BACKGROUND OF THE INVENTION

1. Field of the Invention

The invention relates to an electrical connector, and more particularly, to a power connector.

2. Description of Related Art

Electronic devices are generally equipped with electrical connectors of various specifications to electrically connect to other electronic devices in order to transmit signals or supply power. For connecting to the power supplies, the electronic devices generally have the corresponding power receptacle connectors, so as to obtain the electric power supplied by plugging the power plug connectors of the power supplies into the power receptacle connectors of the electronic devices. A conventional power receptacle connector is generally assembled on the mainboard of an electronic device in a soldering manner, and a plug hole of the power receptacle connector is aligned with an opening of the casing of the electronic device in order to be plugged by the power plug connector of the power supply.

Taiwan Patent No. M419277 discloses a power connector, which a center terminal is inserted into a plug hole of a main body, and a rear end of the center terminal forms a soldering portion to be soldered to a circuit board. However, when the power plug connector of the power supply is frequently plugged into and unplugged from a power receptacle connector of the electronic device, the solder located between the terminal of the power receptacle connector and a soldering hole of the circuit board separates easily from the surface of the terminal, thereby causing the connection area between the terminal and the solder to reduce, and even the terminal and the solder are not connected at all, the electric current path is interrupted. Therefore, the conventional way is changed to electrically connect the power receptacle connector and the circuit board with each other by cables, but this also causes the costs of components and assembly to increase.

### SUMMARY OF THE INVENTION

The invention is directed to a power connector suitable for being mounted on a circuit board.

The invention is directed to a center terminal suitable for being utilized in a power connector to be soldered to a circuit board.

The invention provides a power connector suitable for being mounted on a circuit board. The power connector comprises an insulating housing and a center terminal. The insulating housing has a plug hole. The center terminal has a center fixing portion, a center contact portion and a center soldering portion. The center fixing portion is fixed into the insulating housing, the center contact portion extends into the plug hole, and the center soldering portion is suitable for passing through a center soldering hole of the circuit board to be soldered to the circuit board. The center soldering portion has a waist segment and a tail segment extending from the waist segment, the waist segment is located inside the center soldering hole, and the minimum transection area of the waist segment is less than the maximum transection area of the tail segment.

The invention provides a center terminal suitable for being utilized in a power connector to be soldered to a circuit board. The center terminal comprises a center fixing portion, a center contact portion and a center soldering portion. The center fixing portion is suitable for being fixed to an insulating housing of the power connector. The center contact portion extends from the center fixing portion and is suitable for extending to a plug hole of the insulating housing. The center soldering portion extends from the center fixing portion. The center soldering portion is suitable for passing through a center soldering hole of the circuit board to be soldered to the circuit board, and the center soldering portion has a waist segment and a tail segment extending from the waist segment, the waist segment is located inside the center soldering hole, and the minimum transection area of the waist segment is less than the maximum transection area of the tail segment.

Accordingly, in the invention, after the center soldering portion of the center terminal is soldered to the center soldering hole of the circuit board, the solder extends towards the waist segment by the waist segment of the center soldering portion to produce the fastening effect. Therefore, in comparison with a center terminal of a conventional technique without a waist segment, the center soldering portion of the invention with a waist segment facilitates to improve the soldering strength.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are respectively a top view and a bottom view illustrating the exploded structure of a power connector according to an embodiment of the invention.

FIG. 2A and FIG. 2B are respectively a top perspective view and a bottom perspective view illustrating a power connector of FIG. 1A after being assembled.

FIG. 3A and FIG. 3B are respectively top perspective views illustrating a power connector of FIG. 2A before and after being mounted to a circuit board.

FIG. 4A and FIG. 4B are respectively a front view and a right side view illustrating a power connector of FIG. 3B after being mounted to a circuit board.

FIG. 5A is a cross-sectional view illustrating a power connector of FIG. 3B after being mounted to a circuit board along a center contact portion of a center terminal.

FIG. 5B is a partial enlarged view of FIG. 5A.

### DESCRIPTION OF THE EMBODIMENTS

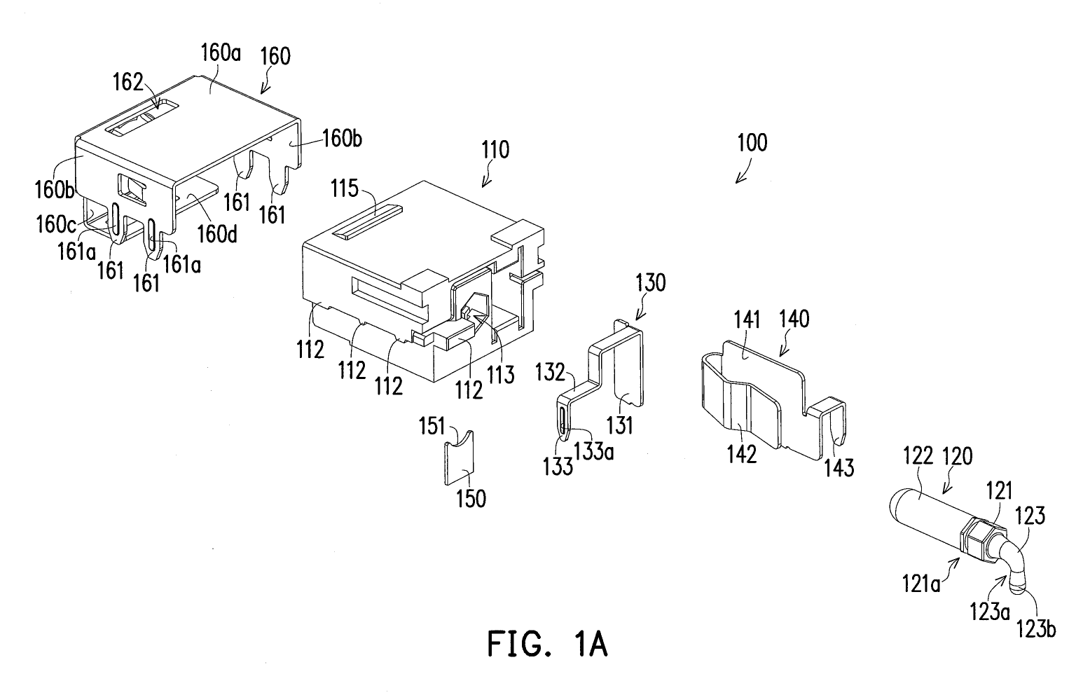

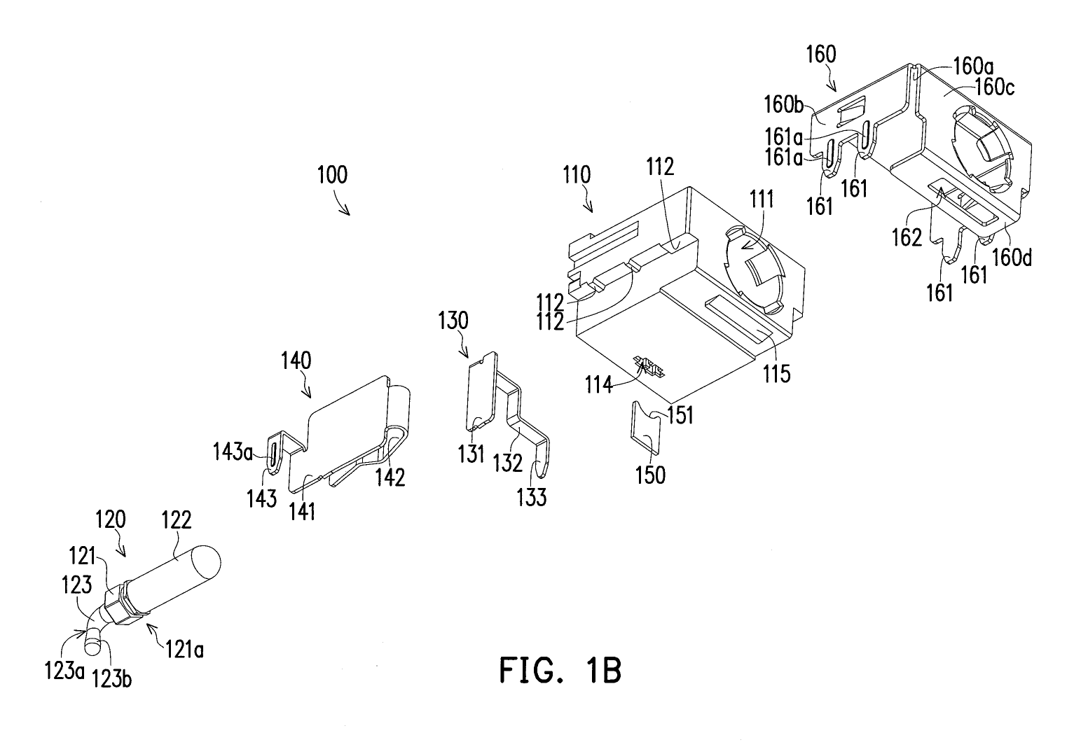

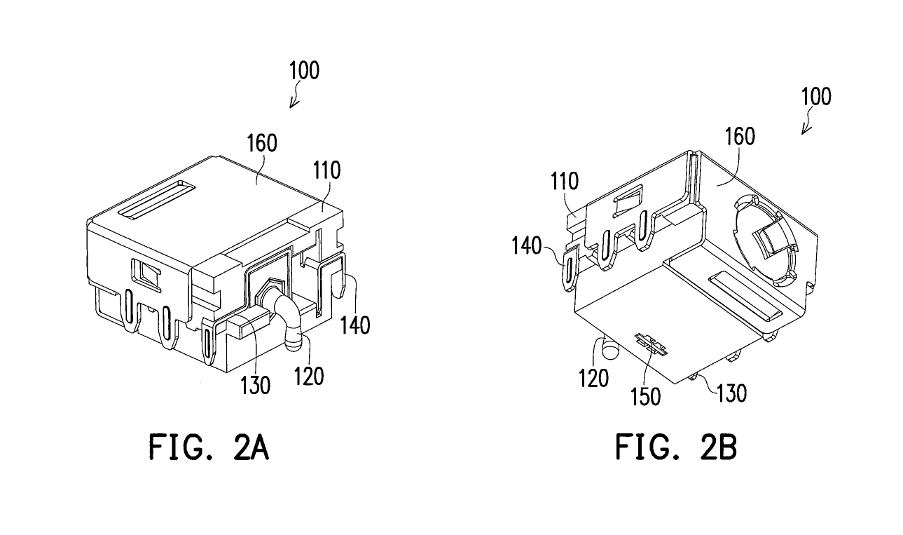

FIG. 1A and FIG. 1B respectively are a top view and a bottom view illustrating the exploded structure of a power connector according to an embodiment of the invention, and FIG. 2A and FIG. 2B respectively are a top perspective view and a bottom perspective view illustrating a power connector of FIG. 1A after being assembled. Referring to FIG. 1A, FIG. 1B, FIG. 2A and FIG. 2B, the power connector 100 of the embodiment comprises an insulating housing 110 and a center terminal 120.

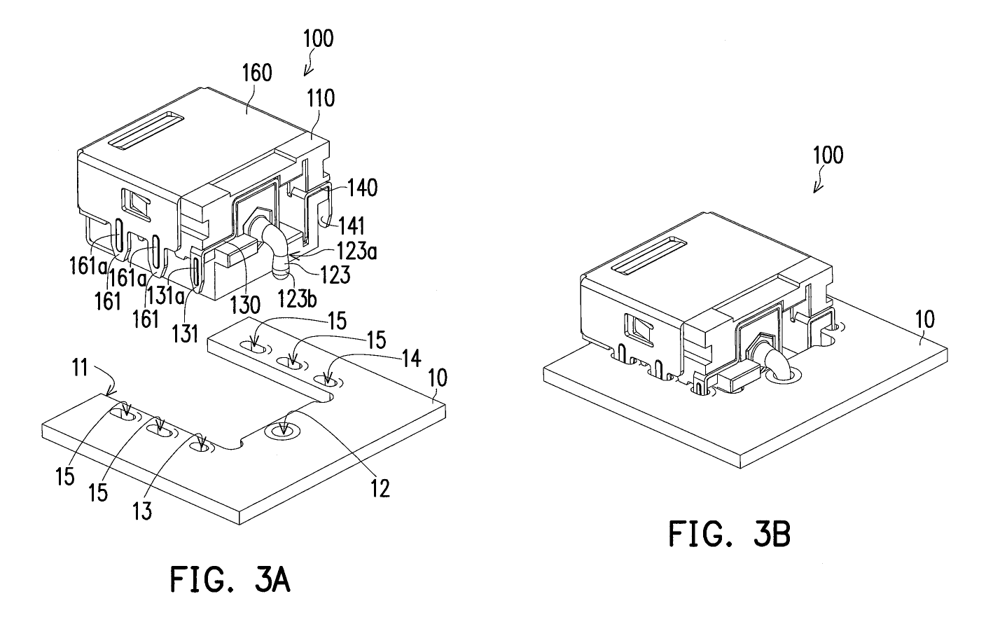

The insulating housing 110 has a plug hole 111. The center terminal 120 has a center fixing portion 121, a center contact portion 122 and a center soldering portion 123. The center fixing portion 121 is fixed into the insulating housing 110, the center contact portion 122 extends from the center fixing portion 121 and extends into the plug hole 111, and the center soldering portion 123 extends from the center fixing portion 121 and is suitable for being soldered to a circuit board 10 illustrated in FIG. 3A.

In the embodiment, a material of the center terminal 120 (that is, the center fixing portion 121, the center contact portion 122 and the center soldering portion 123) may be zinc alloy to enhance the hardness of the center terminal 120. In addition, the center terminal 120 (that is, the center fixing portion 121, the center contact portion 122 and the center soldering portion 123) may be a die casting element, that is, a workpiece fabricated in the die casting manner to prevent the residual internal stress. Moreover, the center soldering portion 123 may extend in L shape from the center fixing portion 121 to be soldered to the circuit board 10 illustrated in FIG. 3A.

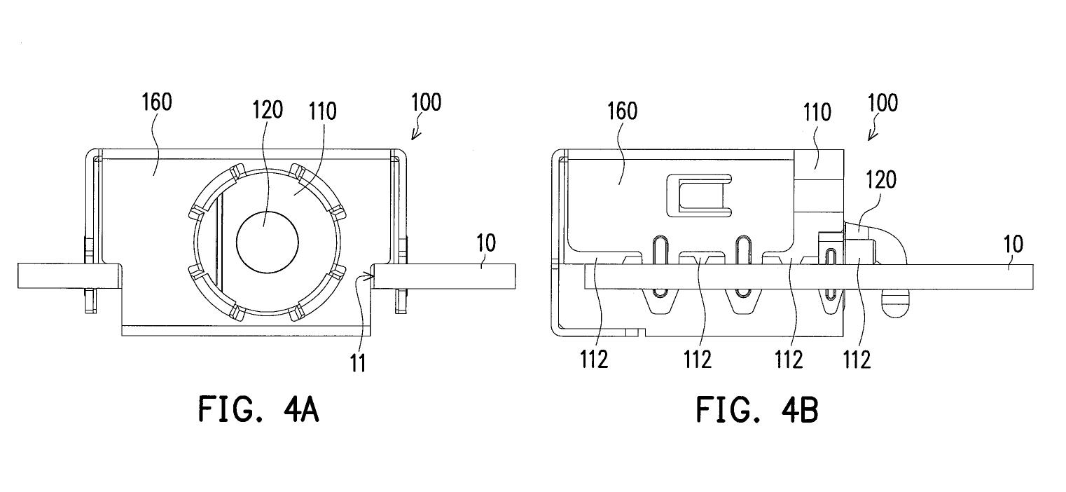

FIG. 3A and FIG. 3B respectively are top perspective views illustrating a power connector of FIG. 2A before and after being mounted to a circuit board, and FIG. 4A and FIG. 4B respectively are a front view and a right side view illustrating a power connector of FIG. 3B after being mounted to a circuit board. Referring to FIG. 3A, FIG. 3B, FIG. 4A and FIG. 4B, the power connector 100 is suitable for being mounted on the circuit board 10. The circuit board 10 has a notch 11, and the insulating housing 110 is disposed through the notch 11. The circuit board 10 has a center soldering hole 12, and the center soldering portion 123 is suitable for passing through the center soldering hole 12 to be soldered to the circuit board 10.

Referring to FIG. 1A, FIG. 1B, FIG. 4A and FIG. 4B, the insulating housing 110 has a plurality of leaning portions 112 to lean on the circuit board 10, especially lean on the periphery of the notch 11. Therefore, the leaning portions 112 may prevent the insulating housing 110 from being overturned in relative to the circuit board 10, so as to prevent damaging the soldering structure between the center terminal 120 and the circuit board 10.

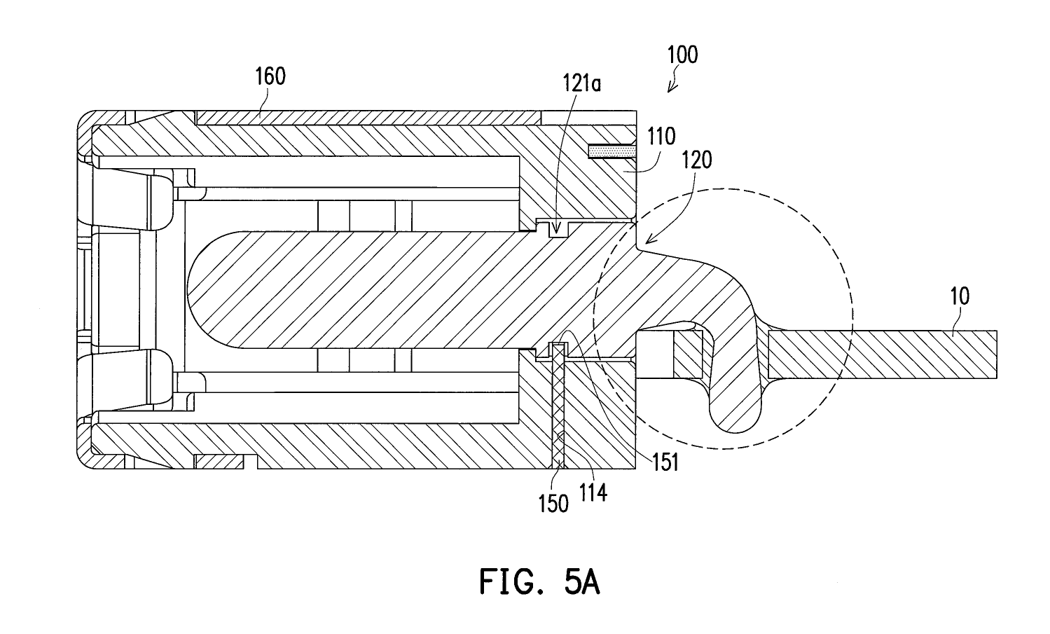

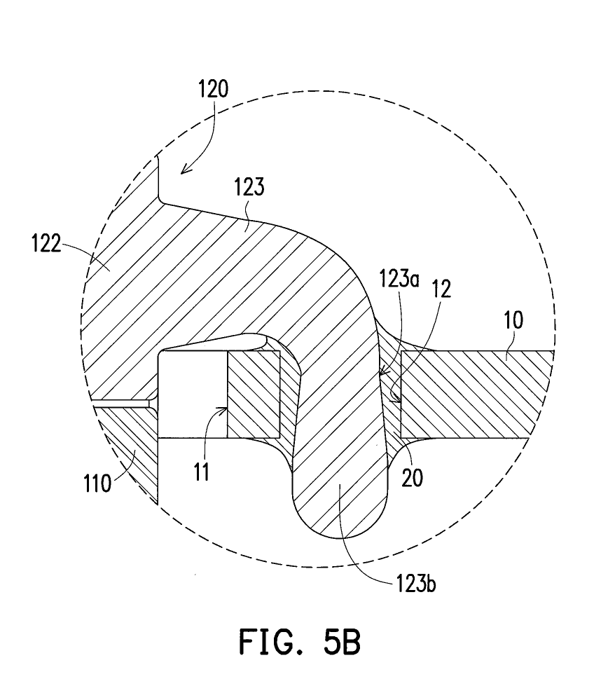

FIG. 5A is a cross-sectional view illustrating a power connector of FIG. 3B after being mounted to a circuit board along a center contact portion of a center terminal, and FIG. 5B is a partial enlarged view of FIG. 5A. Referring to FIG. 5A and FIG. 5B, for strengthening the soldering structure between the center terminal 120 and the circuit board 10, the center soldering portion 123 has a waist segment 123a, and the waist segment 123a is located inside the center soldering hole 12. After soldering, a solder 20 is located between the waist segment 123a and the center soldering hole 12. Since the waist segment 123a is with the concave contour, the solder 20 extends towards the waist segment 123a to produce the fastening effect. Therefore, the waist segment 123a facilitates to improve the soldering strength. In the embodiment, the center soldering portion 123 further has a tail segment 123b, which extends from the waist segment 123a, and the minimum transection area of the waist segment 123a is less than the maximum transection area of the tail segment 123b.

Referring to FIG. 1A, FIG. 1B, FIG. 2A, FIG. 2B, FIG. 3A and FIG. 3B, the power connector 100 may further comprise a first terminal 130, the first terminal 130 has a first fixing portion 131, a first contact portion 132 and a first soldering portion 133. The first fixing portion 131 is fixed into the insulating housing 110, the first contact portion 132 extends into the plug hole 111, and the first soldering portion 133 is suitable for being soldered to the circuit board 10. More specifically, the first soldering portion 133 passes through a first soldering hole 13 of the circuit board 10 to be soldered to the circuit board 10. The first soldering portion 133 has a first reinforcing rib 133a, and the first reinforcing rib 133a is located inside the corresponding first soldering hole 13. The first reinforcing rib 133a facilitates to improve the soldering strength.

In addition, the power connector 100 may further comprise a second terminal 140, the second terminal 140 has a second fixing portion 141, a second contact portion 142 and a second soldering portion 143. The second fixing portion 141 is fixed into the insulating housing 110, the second contact portion 142 extends into the plug hole 111, and the second soldering portion 143 is suitable for being soldered to the circuit board 10. More specifically, the second soldering portion 143 passes through a second soldering hole 14 of the circuit board 10 to be soldered to the circuit board 10. The second soldering portion 143 has a second reinforcing rib 143 a, and the second reinforcing rib 143a is located inside the corresponding second soldering hole 14. The second reinforcing rib 143a facilitates to improve the soldering strength.

In the embodiment, the center terminal 120 may be a power terminal, the first terminal 130 may be a ground terminal, and the second terminal 140 may be a detecting terminal.

Referring to FIG. 1B, FIG. 2B and FIG. 5A, for fixing the center terminal 120 to the insulating housing 110, the power connector 100 may further comprise a stopping element 150, and the stopping element 150 has a stopping portion 151. The insulating housing 110 has a fixing hole 113 and a stopping hole 114, and the center fixing portion 121 of the center terminal 120 has a stopping groove 121a. The center fixing portion 121 engages with the fixing hole 113, the stopping element 150 is inserted at the stopping hole 114, and the stopping portion 151 engages with the stopping groove 121a to fix the center terminal 120 into the insulating housing 110. In the embodiment, the center fixing portion 121 and the fixing hole 113 are in polygonal pillar shape.

Referring to FIG. 1A, FIG. 1B, FIG. 3A and FIG. 3B, the power connector 100 further comprises a shielding cover 160. The shielding cover 160 is fixed onto the insulating housing 110. The shielding cover 160 has a plurality of shielding soldering portions 161, and these shielding soldering portions 161 are suitable for being soldered to the circuit board 10. More specifically, these shielding soldering portions 161 are suitable for respectively passing through a plurality of shielding soldering holes 15 of the circuit board 10 to be soldered to the circuit board 10. Each of the shielding soldering portions 161 has a shielding reinforcing rib 161a, and the shielding reinforcing rib 161a is located inside the corresponding shielding soldering hole 15.

In the embodiment, the shielding cover 160 comprises a top wall 160a, two side walls 160b extending from two opposite sides of the top wall 160a, a front wall 160c extending from a front side of the top wall 160a, and a bottom wall 160d extending from a bottom side of the front wall 160c. These shielding soldering portions 161 respectively extend in parallel from the bottom sides of these side walls 160b. In addition, the insulating housing 110 has a plurality of latching portions 115. The shielding cover 160 has a plurality of latching holes 162, and these latching portions 115 respectively latch with these latching holes 162 to fix the shielding cover 160 onto the insulating housing 110.

According to the above description, in the invention, after the center soldering portion of the center terminal is soldered to the center soldering hole of the circuit board, the solder extends towards the waist segment by the waist segment of the center soldering portion to produce the fastening effect. Therefore, in comparison with a center terminal of the conventional technique without a waist segment, the center soldering portion of the invention with a waist segment facilitates to improve the soldering strength. In addition, the material of the center terminal may be zinc alloy to enhance the hardness of the center terminal, and the center terminal may be a die casting element to prevent the residual internal stress, where all of these facilitate to improve the service lifetime.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power connector suitable for being mounted on a circuit board, the power connector comprises:
an insulating housing having a plug hole; and
a center terminal having a center fixing portion, a center contact portion and a center soldering portion, the center fixing portion is fixed inside the insulating housing, the center contact portion extends into the plug hole, the center soldering portion is suitable for passing through a center soldering hole of the circuit board to be soldered to the circuit board, the center soldering portion has a waist segment and a tail segment extending from the waist segment, the waist segment is located inside the center soldering hole, and a minimum transection area of the waist segment is less than a maximum transection area of the tail segment.

2. The power connector as recited in claim 1, wherein a material of the center terminal is zinc alloy.

3. The power connector as recited in claim 1, wherein the center terminal is a die casting element.

4. The power connector as recited in claim 1, wherein the insulating housing is disposed through a notch of the circuit board, and the insulating housing has a plurality of leaning portions to be suitable for leaning on the circuit board.

5. The power connector as recited in claim 1, further comprising:
a first terminal having a first fixing portion, a first contact portion and a first soldering portion, the first fixing portion is fixed into the insulating housing, the first contact portion extends into the plug hole, and the first soldering portion is suitable for being soldered to the circuit board.

6. The power connector as recited in claim 5, wherein the first soldering portion is suitable for passing through a first soldering hole of the circuit board to be soldered to the circuit board, the first soldering portion has a first reinforcing rib and the first reinforcing rib is located inside the corresponding first soldering hole.

7. The power connector as recited in claim 4, wherein the center terminal is a power terminal, and the first terminal is a ground terminal.

8. The power connector as recited in claim 4, further comprising:
a second terminal having a second fixing portion, a second contact portion and a second soldering portion, the second fixing portion is fixed into the insulating housing, the second contact portion extends into the plug hole, and the second soldering portion is suitable for being soldered to the circuit board.

9. The power connector as recited in claim 8, wherein the second soldering portion is suitable for passing through a second soldering hole of the circuit board to be soldered to the circuit board, the second soldering portion has a second reinforcing rib and the second reinforcing rib is located inside the corresponding second soldering hole.

10. The power connector as recited in claim 8, wherein the center terminal is a power terminal, the first terminal is a ground terminal, and the second terminal is a detecting terminal.

11. The power connector as recited in claim 1, further comprising:
a stopping element having a stopping portion, the insulating housing has a fixing hole and a stopping hole, the center fixing portion of the center terminal has a stopping groove, the center fixing portion engages with the fixing hole, the stopping element is inserted at the stopping hole, and the stopping portion engages with the stopping groove to fix the center terminal into the insulating housing.

12. The power connector as recited in claim 11, wherein the center fixing portion and the fixing hole are in polygonal pillar shape.

13. The power connector as recited in claim 1, further comprising:
a shielding cover fixed onto the insulating housing and having a plurality shielding soldering portions, and the shielding soldering portions are suitable for being soldered to the circuit board.

14. The power connector as recited in claim 13, wherein the shielding soldering portions are suitable for respectively passing through a plurality of shielding soldering holes of the circuit board to be soldered to the circuit board, each of the shielding soldering portions has a shielding reinforcing rib, and the shielding reinforcing rib is located inside the corresponding shielding soldering hole.

15. The power connector as recited in claim 13, wherein the shielding cover comprises a top wall, two side walls extending from two opposite sides of the top wall, a front wall extending from a front side of the top wall and a bottom wall extending from a bottom side of the front wall, and the shielding soldering portions respectively extend in parallel from the bottom sides of the side walls.

16. The power connector as recited in claim 13, wherein the insulating housing has a plurality of latching portions, the shielding cover has a plurality of latching holes, and the latching portions respectively latch with the latching holes to fix the shielding cover onto the insulating housing.

17. A center terminal suitable for being utilized in a power connector to be soldered to a circuit board, the center terminal comprises:
a center fixing portion suitable for being fixed to a insulating housing of the power connector;
a center contact portion extending from the center fixing portion and suitable for extending to a plug hole of the insulating housing; and
a center soldering portion extending from the center fixing portion, wherein the center soldering portion is suitable for passing through a center soldering hole of the circuit board to be soldered to the circuit board, the center soldering portion has a waist segment and a tail segment extending from the waist segment, the waist segment is located inside the center soldering hole, and a minimum transection area of the waist segment is less than a maximum transection area of the tail segment.

18. The center terminal as recited in claim 17, wherein materials of the center fixing portion, the center contact portion and the center soldering portion are zinc alloy.

19. The center terminal as recited in claim 17, wherein the center fixing portion, the center contact portion and the center soldering portion are constructed of a die casting element.

20. The center terminal as recited in claim 17, wherein the center soldering portion extends in L shape from the center fixing portion.
